(19) United States
(12) Patent Application Publication
(10) Pub. No.: US 2013/0042686 A1
(43) Pub. Date: Feb. 21, 2013

(54) INERTIA SENSING APPARATUS

(71) Applicants: CHIUNG-WEN LIN, HSINCHU COUNTY (TW); HUAN-HSIANG WENG, HSINCHU COUNTY (TW); CHIA YU WU, HSINCHU COUNTY (TW)

(72) Inventors: CHIUNG-WEN LIN, HSINCHU COUNTY (TW); HUAN-HSIANG WENG, HSINCHU COUNTY (TW); CHIA YU WU, HSINCHU COUNTY (TW)

(73) Assignee: SITRONIX TECHNOLOGY CORP., HSINCHU COUNTY (TW)

(21) Appl. No.: 13/211,361

(22) Filed: Aug. 17, 2011

(51) Int. Cl. G01P 15/125; G01P 15/00

(52) U.S. Cl. 73/514.32; 73/514.16

(57) ABSTRACT

The invention relates to an inertia sensing apparatus, comprising a substrate, a first and second inertia sensing elements. The first inertia sensing element is connected to a substrate and has a containment space. The second inertia sensing element is connected to the substrate and is disposed in the containment space of the first inertia sensing element, wherein the first inertia sensing element and the second sensing element are connected to the substrate, and the first inertia sensing element and the second sensing element are not connected to each other, the first inertia sensing element and the second sensing element individually and independently detect at least one inertia motion of the inertia sensing apparatus. Therefore, the invention is based on the second inertia sensing element disposed in the containment space of the first inertia sensing element and they individually and independently detect at least one inertia motion of the inertia sensing apparatus, so as to decrease an area of the inertia sensing apparatus, thus reducing the chip size and prevent the two inertia sensing elements from coupling to result in decreasing the sensing precision.

### FIELD OF THE INVENTION

The invention relates to an inertia sensing apparatus, and particularly to reduce the overall chip size and increase the sensing capability of the inertia sensing apparatus.

### BACKGROUND OF THE INVENTION

To increase the functionality of the electronic products in the consumer electronics device today, motion based control has became the fastest growing integration aspect in this trend. The sensing apparatus which can detect the inertia motion, such as the device that can detect the acceleration or angular velocity, need to be assembled accurately. Generally, any directional acceleration and any rotational angular velocity are acted on an object which moves freely in three-dimensional space. To control the motion of the object accurately, accelerations in the X-, Y-, and Z-axes and angular velocities around the X-, Y-, and Z-axes need to be detected. Certainly, it is essential to have an inertia sensing apparatus, which has the following merits like compact size, higher resolution, and lower production cost.

As mentioned above, an accelerometer is used to detect an acceleration induced by an external acceleration force. The accelerometer can be applied in various fields, such as the vehicle automatic safety system in order to collect the kinetic energy of the vehicle and the external force acting on the vehicle. Nowadays the main driving force is coming from the electronic products based on the rapidly development of human-computer interaction. That is the intuitive operating mode of the human body. For example, the switching of the screen by the flip of the electronic products will make the user interface simplify, further to enhance the user experience. Most electronic products of the above-mentioned are using an inertia sensing apparatus, such as an accelerometer, to attain the functions. When applying an external force on the accelerometer, the mechanical system will be changed (compared to its original position). Thus, the external force can be calculated by the various electrical sensing methods. Micro-accelerometer, which comprised of a mechanical device fabricated by micromachining technology and a electrical circuit, has became the superior choice since it can cut down the power consumption with reduced space consuming and increased products reliability.

Based on the different sensing mechanism, accelerometer can be classified into the following types: piezoresistive, capacitive and piezoelectric sensing mechanism, wherein a capacitive accelerometer detect the acceleration by measuring the capacitance variance. Based on different design mechanism, it can be classified into out-of-plane and in-plane motion. Large area parallel-plate electrodes and comb electrodes are generally used in out-of-plane and in-plane sensing mechanisms, respectively.

FIG. 1 shows a structural schematic diagram of an acceleration sensing apparatus according to the prior art. As shown in the figure, the acceleration sensing apparatus of the prior art comprises an X-axis accelerometer 10′, a Y-axis accelerometer 20′, and a Z-axis accelerometer 30′. For the acceleration sensing apparatus 1′ of the prior art, to detect the X-, Y- and Z-axis accelerations simultaneously, it uses an X-axis accelerometer 10′, a Y-axis accelerometer 20′ and a Z-axis accelerometer 30′ to detect an X-axis acceleration, a Y-axis acceleration, and a Z-axis acceleration, respectively. However, in order to increase the competitiveness of the product, decreasing the size of the accelerometer is certainly one development trend. It can decrease the cost as well since it can be easily integrated in the hand-held mobile products. However, while reducing the size of the Z-axis accelerometer, asymmetry of the proof mass will be lessened. Thus, the displacement of the proof mass will be decreased and so does the capacitance value difference. Then it will increase the difficulties for capacitance sensing circuit during detection.

Another method for increasing the output signal is to enlarge the proof mass of the acceleration sensing apparatus. A heavier proof mass is incorporated to detect three axial accelerations. Therefore, fabrication process must be modified to achieve this goal. Another effective way is to utilize one single proof mass for 3 axes detection. The sensing accuracy of the device will be decreased due to signal coupling.

Therefore, according to the above problems, the present invention proposes a novel sensing apparatus to decrease the area of the inertia sensing apparatus efficiently.

### SUMMARY

An objective of the present invention is to provide an inertia sensing apparatus. A second inertia sensing element is disposed in a containment space of a first inertia sensing element, and they detect the inertia motion of the inertia sensing apparatus individually and independently. As a result, area of the inertia sensing apparatus can be decreased and reduce the overall chip size while the sensing capability of the inertia sensing apparatus is increased.

Another objective of the present invention is to provide an inertia sensing apparatus. By disposing a second inertia sensing element in the containment space of a first inertia sensing element, it can increase asymmetry of the proof mass for the first sensing element and enhance the sensing ability of the first inertia sensing element.

The present invention relates to an inertia sensing apparatus, which comprises a substrate, a first inertia sensing element and a second inertia sensing element. The first inertia sensing element is connected to a substrate and has a containment space. The second inertia sensing element is connected to the substrate and is disposed in the containment space of the first inertia sensing element, wherein, the first inertia sensing element and the second inertia sensing element are connected to the substrate, the first inertia sensing element and the second sensing element are not connected to each other, the first inertia sensing element and the second inertia sensing element detect at least one inertia motion of the inertia sensing apparatus individually and independently. Therefore, the invention is based on the second inertia sensing element disposed in the containment space of the first inertia sensing element and they detect at least one inertia motion of the inertia sensing apparatus individually and independently.

Furthermore, the first and the second inertia sensing elements of the present invention are acceleration sensing elements. The inertia motion comprises the accelerations in the first and the second directions of the inertia sensing apparatus. The acceleration in the first direction is detected by the first inertia sensing element and the acceleration in the second direction is detected by the second inertia sensing element. By disposing the second inertia sensing element in the containment space of the first inertia sensing element, it can increase asymmetry of the mass for the first sensing element and enhance the sensing ability of the first inertia sensing element.

### BRIEF DESCRIPTION OF THE DRAWINGS

FIG. 1 shows a structural schematic diagram of an acceleration sensing apparatus according to the prior art;

FIG. 2 shows a structural schematic diagram according to a preferred embodiment of the present invention;

FIG. 3A shows a front view of a structural schematic diagram according to a preferred embodiment of the present invention;

FIG. 3B shows an operating diagram of an inertia sensing apparatus of FIG. 3A;

FIG. 3C shows a front view of the inertia sensing apparatus according to a preferred embodiment of the present invention;

FIG. 3D shows an operating diagram of the inertia sensing apparatus of FIG. 3C;

FIG. 4 shows another structural schematic diagram according to another preferred embodiment of the present invention;

FIG. 5 shows another structural schematic diagram according to another preferred embodiment of the present invention;

FIG. 6 shows another structural schematic diagram according to another preferred embodiment of the present invention; and

FIG. 7 shows another structural schematic diagram according to another preferred embodiment of the present invention.

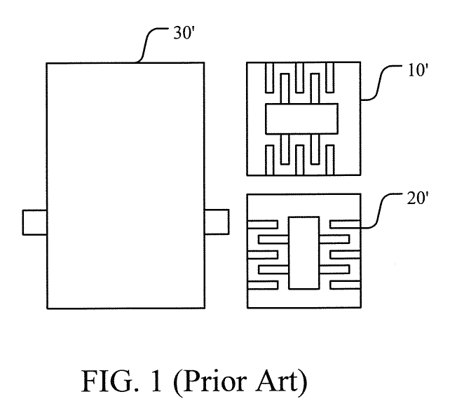

### DETAILED DESCRIPTION

In order to make the structure and characteristics as well as the effectiveness of the present invention to be further understood and recognized, the detailed description of the present invention is provided as follows along with preferred embodiments and accompanying figures.

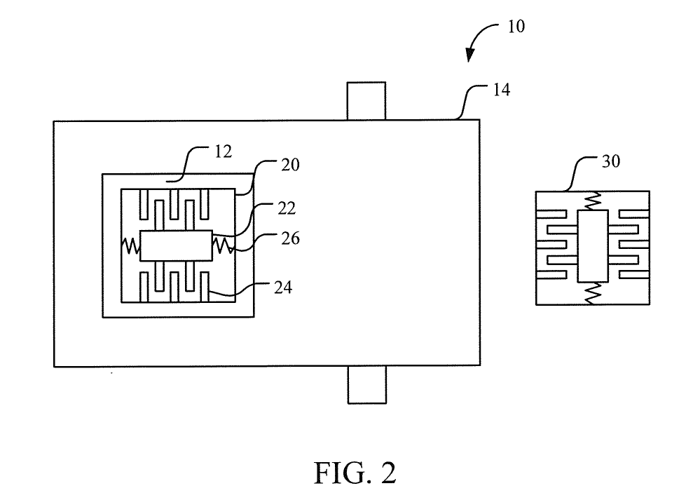

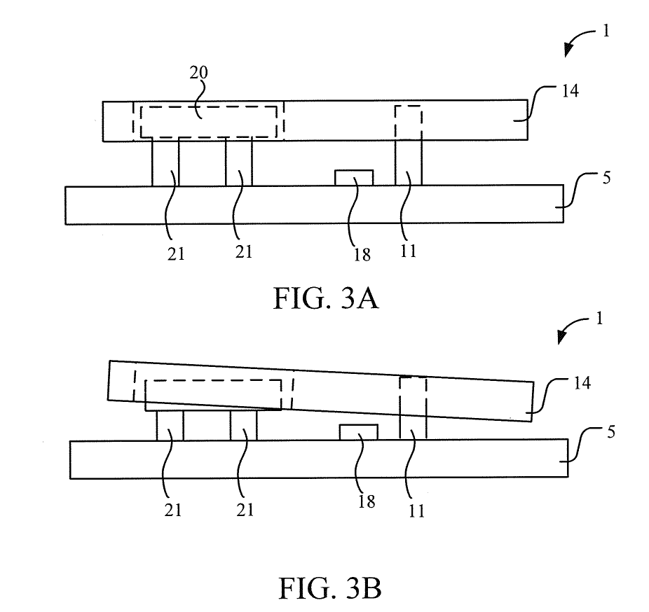

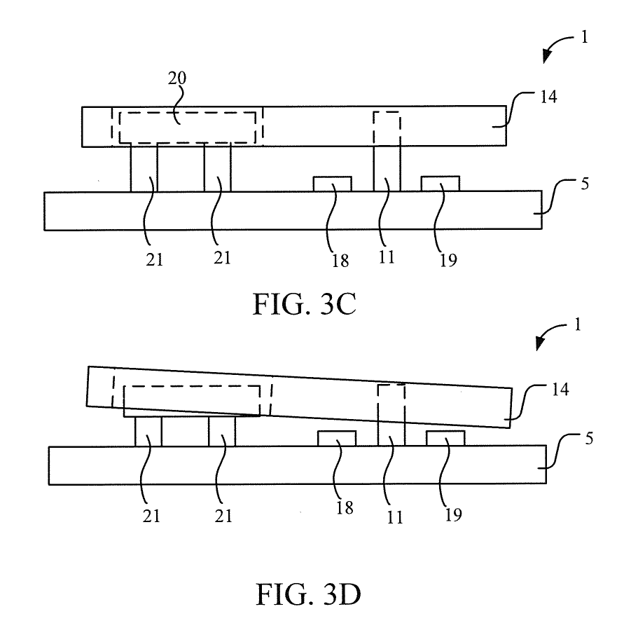

According to a preferred embodiment of the present invention, FIG. 2, FIG. 3A and FIG. 3B show a structural schematic diagram, a front view of the structure, and an operating schematic diagram, respectively. As shown in the figure, the inertia sensing apparatus 1 of the present invention comprises a substrate 5, a first inertia sensing element 10 and a second inertia sensing element 20. The first inertia sensing element 10 is connected to the substrate 5 and has a containment space 12. The second inertia sensing element 20 is connected to the substrate 5 and is disposed in the containment space 12 of the first inertia sensing element 10, wherein, the first inertia sensing element 10 and the second inertia sensing element 20 are connected to the substrate 5, the first inertia sensing element 10 and the second sensing element 20 are independent and not connected to each other, the first inertia sensing element 10 and the second inertia sensing element 20 individually and independently detect at least one inertia motion of the inertia sensing apparatus 1, so as to decrease an area of the inertia sensing apparatus, reduce overall chip size. Furthermore, the first inertia sensing element 10 and the second inertia sensing element 20 are connected to the substrate 5 and the first inertia sensing element 10 and the second inertia sensing element 20 are not connected to each other. That can prevent the first inertia sensing element 10 and the second inertia sensing element 20 from coupling, so as to increase the sensing capability of the inertia sensing apparatus 1.

Moreover, the first inertia sensing element 10 and the second inertia sensing element 20 include a first part 11 and at least one fixed part 21, respectively. (refer to FIG. 3A) The first inertia sensing element 10 and the second inertia sensing element 20 are supported on the substrate 5 by the first fixed part 11 and the second fixed part 21. In addition to the first inertia sensing element 10 and the second inertia sensing element 20 being connected to the substrate 5, they are not connected to each other and individually and independently detect at least one inertia motion of the inertia sensing apparatus 1. Therefore, the invention is based on the second inertia sensing element 20 disposed in the containment space of the first inertia sensing element 10. Inertia sensing elements 10 and 20 detect at least one inertia motion of the inertia sensing apparatus 1 individually and independently in order to decrease the area of the inertia sensing apparatus 1, thus reducing the chip size and prevent the two inertia sensing elements from coupling to enhance the sensing ability of the first inertia sensing element 1.

In accordance with one embodiment, the first inertia sensing element 10 and the second inertia sensing element 20 are acceleration sensing elements, and the inertia motion comprises the accelerations in a first direction and a second direction of the inertia sensing apparatus 1. So, the acceleration in the first direction is detected by the first inertia sensing element 10 and the acceleration in the second direction is detected by the second inertia sensing element 20. Besides, the accelerations of the first direction and the second direction detected by the first inertia sensing element 10 can be the accelerations in the same direction and not be limited in the accelerations in different directions.

The acceleration in the first direction detected by the first inertia sensing element is the acceleration in the Z direction and the acceleration in the second direction detected by the second inertia sensing element is the acceleration in the X direction or Y direction. Furthermore, the inertia sensing apparatus 1 further comprises a third inertia sensing element 30. The third inertia sensing element 30 is disposed in one side of the first inertia sensing element 10 and the third inertia sensing element 30 is the acceleration sensing element which detect the acceleration of the inertia sensing apparatus 1 in a third direction. In one particular embodiment, the accelerations in the X, Y and Z directions detected by the inertia sensing apparatus 1 need three inertia sensing elements. The first inertia sensing element 10 is the Z-direction acceleration sensing element, the second inertia sensing element 20 can be the X-direction acceleration sensing element and the third inertia sensing element 30 can be the Y-direction acceleration sensing element; or, the second inertia sensing element 20 can be the Y-direction acceleration sensing element and the third inertia sensing element 30 can be the X-direction acceleration sensing element, wherein, the first inertia sensing element 10, the second inertia sensing element 20 and third inertia sensing element 30 are connected to the substrate 5, the first inertia sensing element 10, the second inertia sensing element 20 and third inertia sensing element 30, which are connected to the substrate 5, are independent and not connected to each other. Therefore, the first inertia sensing element 10, the second inertia sensing element 20 and third inertia sensing element 30 detect the inertia motion of the inertia sensing apparatus 1 individually and independently.

As shown in FIG. 3A and 3B, the first inertia sensing element 10 of the inertia sensing apparatus 1 is a Z-direction acceleration sensing element. The first inertia sensing element 10 includes a proof mass 14 and a first sensing capacitive plate 18. The proof mass 14 includes at least one set of elastic part 15 (example: spring) and a containment space 12. The elastic part 15 supports the proof mass 14 and the elastic part 15 connects to the fixed part 11. The containment space 12 is located in one side of the elastic part 15 and the proof mass 14 is on the substrate 5. The first sensing capacitive plate 18 is set on the substrate 5 to detect the capacitive variation generated by the displacement of the proof mass 14. Thus the motion of the inertia sensing apparatus 1 can be obtained. According to the present preferred embodiment, the containment space 12 is located in the left side of the elastic part 15 and it can also be located in the right side of the elastic part 15. That can be easily known by a person having ordinary skill in the art, so it will not be described no more here.

According to another preferred embodiment of the present invention, FIG. 3C and FIG. 3D show a front view and an operating diagram of the inertia sensing apparatus. As shown in the figures, the difference between the present preferred embodiment and the embodiment of the FIG. 3A is that the inertia sensing element 10 of the present embodiment further comprises a second sensing capacitive plate 19. The displacement of the proof mass 14 is detected by the first sensing capacitive plate 18 and the second sensing capacitive plate 19 to generate differential sensing signals. The acceleration in the Z direction is attained by the capacitance sensing circuit (not shown in the figure) based on the difference of the sensing signals. In the present preferred embodiment, the first sensing capacitive plate 18 and the second sensing capacitive plate 19 are in two sides of the fixed part 11 to detect the capacitive variance generated by the displacement of the proof mass 14.

The first inertia sensing element 10 is a Z-direction acceleration sensing element which uses the seesaw principle, as using the asymmetric structure of the proof mass to detect the Z-direction acceleration. When an external acceleration force acts on the Z-direction, the heavier side of the proof mass for the sensing element 10 generates the larger number of vertical displacements due to unbalanced moment of the proof mass. According to the present preferred embodiment, as the acceleration in the −Z direction, the gap between the proof mass 14 and the second sensing capacitive plate 19 reduces, the capacitance value between proof mass 14 and the second sensing capacitive plate 19 increase while the capacitance value of the other sensing capacitive plate (the first sensing capacitive plate 18)and proof mass 14 decrease. Therefore, the acceleration can be detected by the capacitance variation of the first inertia sensing element 10 and analyzed by the capacitive differential circuit (not shown in the figures). Because the containment space 12 is located in the side of the first inertia sensing element 10, it can increase the length of moment arm, and further increase the asymmetry of proof mass for the first inertia sensing element 10 and enhance the ability of the first inertia sensing element.

As shown in FIG. 2, the second inertia sensing element 20 of the present invention can be an X-direction acceleration sensing element or a Y-direction acceleration sensing element. In this embodiment, the second inertia sensing element 20 is a X-direction acceleration sensing element which includes a proof mass 22, a plurality of sensing parts 24, and a plurality of elastic parts 26. The sensing parts 24 which present a comb structure and are disposed in two sides of the proof mass 22 to detect the acceleration in the second direction by the displacement of the proof mass 22. The elastic parts 26 are disposed in two sides of the proof mass 22. The sensing parts 20 detect the acceleration in the second direction coming from the displacement of the proof mass 22. Due to the acceleration in the X direction detected by the second acceleration sensing element 20 of the present preferred embodiment, the elastic parts 26 was disposed in two sides of the proof mass 22, so as to the sensing parts 24 detect the acceleration in the X direction by the displacement of the proof mass 22. Because the structure of the second sensing element 20 is well-known by a person having ordinary skill in the art, it will not be described no more here. Similarly, the structure of the third inertia sensing element 30 is the same as the second inertia sensing element 20. The difference between these two inertia sensing elements is detecting the accelerations in different directions, thus, it will not be described no more here.

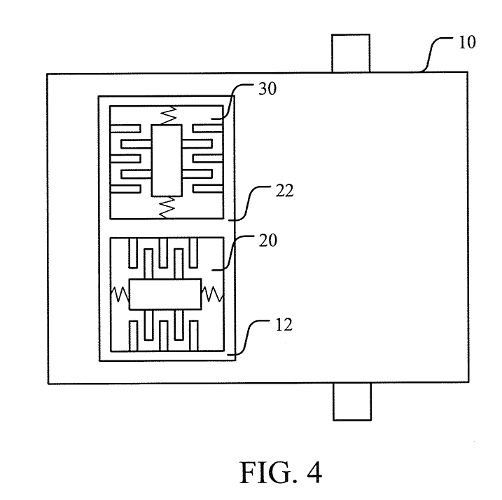

FIG. 4 shows a structural schematic diagram according to another preferred embodiment of the present invention. As shown in the figure, the difference between the present preferred embodiment and the previous one is that in the previous preferred embodiment, the containment space 12 of the first inertia sensing element 10 can dispose a second inertia sensing element 20 and a third inertia sensing element 30 simultaneously and the first inertia sensing element 10, the second inertia sensing element 20, and the third inertia sensing element 30 individually and independently detect the accelerations in the first, the second and the third directions, respectively. That is the accelerations in the X-, Y- and Z-directions and it can decrease an area of the inertia sensing apparatus 1 and reduce chip size.

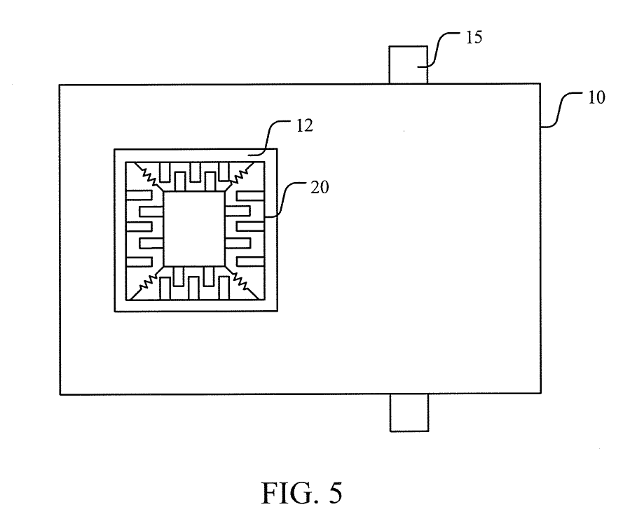

FIG. 5 shows a structural schematic diagram according to another preferred embodiment of the present invention. As shown in the figure, the difference between the present preferred embodiment and the previous one is that in the previous preferred embodiment, the second inertia sensing element 20 of the present embodiment is a multi-direction acceleration sensing element and is disposed in the containment space 12 of the first inertia sensing element 10. The second inertia sensing element 20 is used to detect the inertia motion of the inertia sensing apparatus 1. That is the first inertia sensing element 10 is used to detect the acceleration in the first direction and the second inertia sensing element 20 is used to detect the accelerations in the second and the third directions.

According to the present preferred embodiment, the first direction acceleration of the inertia sensing apparatus 1 detected by the first inertia sensing element 10 is the acceleration in the Z direction and the second and the third direction accelerations detected by the second inertia sensing element 20 are the accelerations in the X direction and the Y direction, respectively. Thus, the preferred embodiment is based on the second inertia sensing element 20 disposed in the containment 12 of the first inertia sensing element 10 to decrease an area of the inertia sensing apparatus 1, reduce the chip size and enhance the sensing capability of the inertia sensing apparatus.

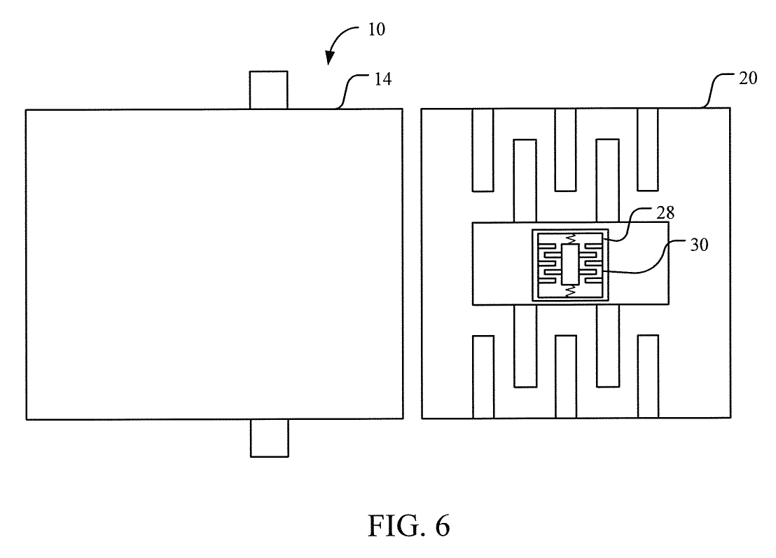

FIG. 6 shows a structural schematic diagram according to another preferred embodiment of the present invention. As shown in the figure, the difference between the present preferred embodiment and the previous one is that in the previous preferred embodiment, the second inertia sensing element 20 in the present preferred embodiment can be set the containment space 28. The containment space 28 can be disposed a third inertia sensing apparatus 30. When the second inertia sensing element 20 is a X-direction acceleration sensing element and the third inertia sensing element 30 is a Y-direction acceleration sensing element, it can be set a containment space 28 in the second inertia sensing element 20 and disposed a third inertia sensing element 30 in the containment space 28. Thus, it can decrease an area of the inertia sensing apparatus 1.

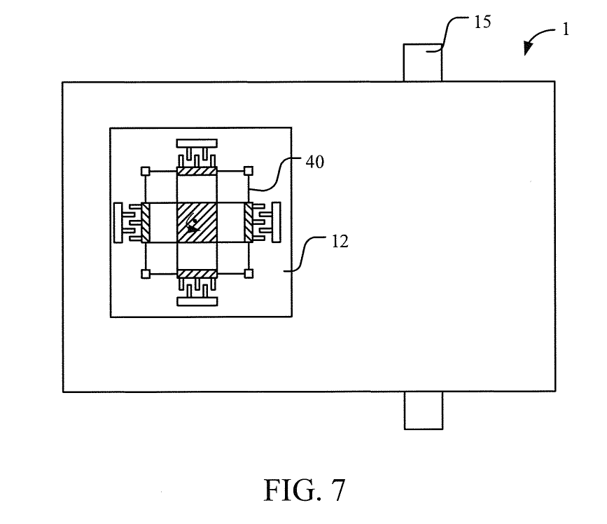

FIG. 7 shows a structural schematic diagram according to another preferred embodiment of the present invention. As shown in the figure, the difference between the present preferred embodiment and the previous one is that in the previous preferred embodiment, the containment space of the first inertia element 10 in the present preferred embodiment can dispose an angular rate sensing element 40 to decrease an area of the sensing apparatus 1, wherein the angular rate sensing element 40 is a gyroscope. Besides, the first inertia sensing element 10 and the second inertia sensing element 20 of the present invention can be an acceleration sensing element, an angular rate sensing element or any combination of these two sensing elements. In other words, apart from the previous embodiment, the first inertia sensing element 10 can be an angular rate sensing element and the second inertia element can be an acceleration sensing element. A person having ordinary skill in the art through the above embodiments can easily know various other combinations, so it will not be described no more here.

To sum up, the inertia sensing apparatus according to the present invention is connected to the substrate and has a containment space. The first inertia sensing element is connected to a substrate and has a containment space. The second inertia sensing element is connected to the substrate and is disposed in the containment space of the first inertia sensing element, wherein, the first inertia sensing element and the second inertia sensing element are connected to the substrate, the first inertia sensing element and the second sensing element are not connected to each other, the first inertia sensing element and the second inertia sensing element are individually and independently detect at least one inertia motion of the inertia sensing apparatus. Therefore, the invention is based on the second inertia sensing element disposed in the containment space of the first inertia sensing element and they individually and independently detect the inertia motion of the inertia sensing apparatus, so as to decrease an area of the inertia sensing apparatus, thus reducing chip size and prevent the two inertia sensing elements from coupling and result in decreasing of the sensing precision.

Accordingly, the present invention conforms to the legal requirements owing to its novelty, non-obviousness, and utility. However, the foregoing description is only a preferred embodiment of the present invention, not used to limit the scope and range of the present invention. Those equivalent changes or modifications made according to the shape, structure, feature, or spirits described in the claims of the present invention are included in the appended claims of the present invention.

1. An inertia sensing apparatus, comprising:
a substrate;
a first inertia sensing element, connected to the substrate and having a containment space; and
a second inertia sensing element, connected to the substrate and disposed in the containment space of the first inertia sensing element;
wherein the first inertia sensing element and the second inertia sensing element connected to the substrate and the first inertia sensing element and the second sensing element are not connected to each other, the first inertia sensing element and the second inertia sensing element detect at least one inertia motion of the inertia sensing apparatus individually and independently.

2. The inertia sensing apparatus of claim 1, wherein the first and the second inertia sensing elements are acceleration sensing elements, and the inertia motion comprises accelerations in a first and a second directions of the inertia sensing apparatus, the acceleration in the first direction is detected by the first inertia sensing element and the acceleration in the second direction is detected by the second inertia sensing element.

3. The inertia sensing apparatus of claim 2, wherein the acceleration in the first direction detected by the first inertia sensing element is the acceleration in the Z direction and the acceleration in the second direction detected by the second inertia sensing element is the acceleration in the X direction or Y direction.

4. The inertia sensing apparatus of claim 2, wherein the acceleration in the first direction detected by the first inertia sensing element is the acceleration in the X direction and the acceleration in the second direction detected by the second inertia sensing element is the acceleration in the Y direction.

5. The inertia sensing apparatus of claim 2, wherein the acceleration sensing element comprising:
a proof mass, having at least one set of elastic device and the containment space, the proof mass is supported by the set of elastic device and the containment space is located in one side of the elastic device and the proof mass is on the substrate; and
at least one sensing capacitive plate, set on the substrate and detects the capacitive variation generated by the displacement of the proof mass to obtain the inertia motion of the inertia apparatus.

6. The inertia sensing apparatus of claim 1, further comprising:
a third inertia sensing element, disposed in the containment space of the first inertia sensing element and independently detects the inertia motion of the inertia sensing apparatus;
wherein the first inertia sensing element, the second inertia sensing element and the third inertia sensing element connected to the substrate, the first inertia sensing element, the second inertia sensing element and the third inertia sensing element are not connected to each other, the first inertia sensing element, the second inertia sensing element and the third inertia sensing element individually and independently detect the inertia motion of the inertia sensing apparatus.

7. The inertia sensing apparatus of claim 1, wherein the first and the second inertia sensing elements are acceleration sensing elements or angular rate sensing elements.

8. An inertia sensing apparatus, comprising:
a substrate;
a first inertia sensing element, connected to the substrate and having a containment space; and
a second inertia sensing element, used to detect a plurality of inertia motion of the inertia sensing apparatus and the second inertia sensing element is connected to the substrate and disposed in the containment space of the first inertia sensing element;
wherein the first inertia sensing element and the second inertia sensing element connected to the substrate and the first inertia sensing element and the second sensing element are not connected to each other, the first inertia sensing element and the second inertia sensing element individually and independently detect at least one inertia motion of the inertia sensing apparatus.

9. The inertia sensing apparatus of claim 8, wherein the first and the second inertia sensing elements are acceleration sensing elements or angular rate sensing elements.

10. The inertia sensing apparatus of claim 8, wherein the first and the second inertia sensing elements are an acceleration sensing elements, the inertia motion comprises an accelerations in a first, a second and a third directions of the inertia sensing apparatus, and the first inertia sensing element detects the acceleration in the first direction, and the second inertia sensing element detects the acceleration in the second direction, and the third inertia sensing element detects the acceleration in the third direction.

11. The inertia sensing apparatus of claim 10, wherein the acceleration in the first direction detected by the first inertia sensing element is the acceleration in the Z direction and the accelerations in the second and the third directions detected by the second inertia sensing element is the accelerations in the X direction and Y direction.
